(19) United States
(12) Patent Application Publication
(10) Pub. No.: US 2026/0148050 A1
(43) Pub. Date: May 28, 2026

(54) ENERGY EFFICIENT CONFIGURATION MANAGEMENT USING QUANTUM-ENHANCED GENERATIVE ADVERSARIAL NETWORK

(71) Applicant: Dell Products L.P., Round Rock, TX (US)

(72) Inventors: Hoda Dehghan, Kanata (CA); Gwenael Poitau, Montreal (CA)

(21) Appl. No.: 18/959,388

(22) Filed: Nov. 25, 2024

(51) Int. Cl. G06N 3/063

(52) U.S. Cl. CPC G06N 3/063

(57) ABSTRACT

A service optimizes a network for improved energy consumption. The service causes a quantum neural network (QNN) to operate on network data to produce a first quantum state and a second quantum state. The service causes a generative adversarial network (GAN) to operate on the first and second quantum states. The GAN generates a first simulation of the network using the first quantum state and a second simulation of the network using the second quantum state. An output of the GAN includes a first set of proposed network settings used as a part of the first simulation and a second set of proposed network settings used as a part of the second simulation. The service causes a configuration management engine (CME) to map the first and second sets of proposed network settings to actual network settings.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to optimizing a network. More particularly, at least some embodiments relate to systems, hardware, software, computer-readable media, and methods for optimizes a network to improve energy consumption of the network.

### BACKGROUND

The integration of energy efficiency constraints into performance-based network management introduces a significant layer of complexity to an already challenging domain. Networks are traditionally optimized for performance, focusing on parameters such as bandwidth, latency, reliability, and throughput to meet the ever-growing demands of users and applications. However, as the digital ecosystem expands and the environmental impact of technology becomes a concern, there is a pressing need to balance these performance objectives with energy efficiency. This balance is not straightforward due to the dynamic and heterogeneous nature of network traffic, the variability in user behavior, and the technological diversity across network infrastructures.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture that optimizes a network.

FIG. 2 illustrates an example process flow for optimizing a network to improve its energy consumption.

FIG. 3 illustrates a flowchart of an example method for optimizing a network.

FIG. 4 illustrates an example computer system that can be configured to perform any of the disclosed operations.

### DETAILED DESCRIPTION

As mentioned, the integration of energy efficiency constraints into performance-based network management introduces a significant layer of complexity to an already challenging domain. Networks are traditionally optimized for performance, focusing on parameters such as bandwidth, latency, reliability, and throughput to meet the ever-growing demands of users and applications. However, as the digital ecosystem expands and the environmental impact of technology becomes a critical concern, there is a pressing need to balance these performance objectives with energy efficiency. This balance is not straightforward due to the dynamic and heterogeneous nature of network traffic, the variability in user behavior, and the technological diversity across network infrastructures.

Adding the constraint of energy efficiency requires an understanding of how different configurations impact both the network's energy consumption and its ability to deliver services effectively. For instance, strategies like powering down idle components or adjusting resource allocations to minimize energy use can inadvertently impact network availability or degrade service quality. Furthermore, the task is compounded by the desire to make these adjustments in real-time or near-real-time, responding to fluctuating network conditions, and responding to demands without compromising user experience.

The challenge is further amplified by the vast amount of data that must be processed to make informed decisions. This data encompasses not only real-time metrics of network performance and energy consumption but also predictive indicators of traffic patterns, user mobility, and service demands. Integrating this data to guide energy-efficient network configurations while maintaining high performance levels requires advanced computational models and algorithms that can handle the complexity and scale of modern networks.

Prior approaches to integrating energy efficiency into network management have traditionally focused on optimizing networks for performance metrics such as bandwidth, latency, reliability, and throughput. These strategies aimed to meet the increasing demands of users and applications, often at the expense of energy consumption. As the environmental impact of technology has become more pressing, there has been a growing need to reconcile these performance goals with the imperative of energy efficiency. This task is complicated by the dynamic nature of network traffic, the diversity of user behavior, and the wide range of technologies that constitute modern network infrastructures.

Historically, methods to enhance energy efficiency in networks have included straightforward strategies such as powering down idle components or adjusting resource allocations based on current demand. However, these approaches often resulted in unintended consequences for network availability and service quality. Moreover, the necessity of making such adjustments in real-time or near-real-time, in response to fluctuating network conditions, adds a layer of complexity to the challenge.

Former approaches also relied heavily on processing vast amounts of data to inform decisions. This data spanned real-time network performance metrics, predictive indicators of traffic patterns, and user mobility, among others. Advanced computational models and algorithms were developed to sift through this data, aiming to identify energy-efficient network configurations that did not compromise performance. However, these models often struggled with the scale and complexity of modern networks, and they typically operated within conventional computational paradigms that limited their ability to manage the multifaceted relationships between network configurations, performance, and energy consumption.

These existing technologies and methods generally lacked the ability to dynamically balance the competing demands of network performance and energy efficiency. They often operated in silos, addressing specific aspects of the problem in isolation and without the benefit of a comprehensive framework that could adapt to the rapidly evolving landscape of network technology and user expectations.

To address these challenges, an innovative solution has been developed that enhances energy efficiency in network systems. That is, the disclosed embodiments bring about numerous benefits, advantages, and practical applications to the field of network systems. The disclosed embodiments are advantageously configured to seamlessly integrate Quantum Neural Networks (QNNs) and Generative Adversarial Networks (GANs) into the network configuration and execution planning processes. This sophisticated solution is designed to address the dual challenges of maintaining high network performance while significantly reducing energy consumption. By performing the disclosed operations, the embodiments are able to improve the operational efficiency of the network.

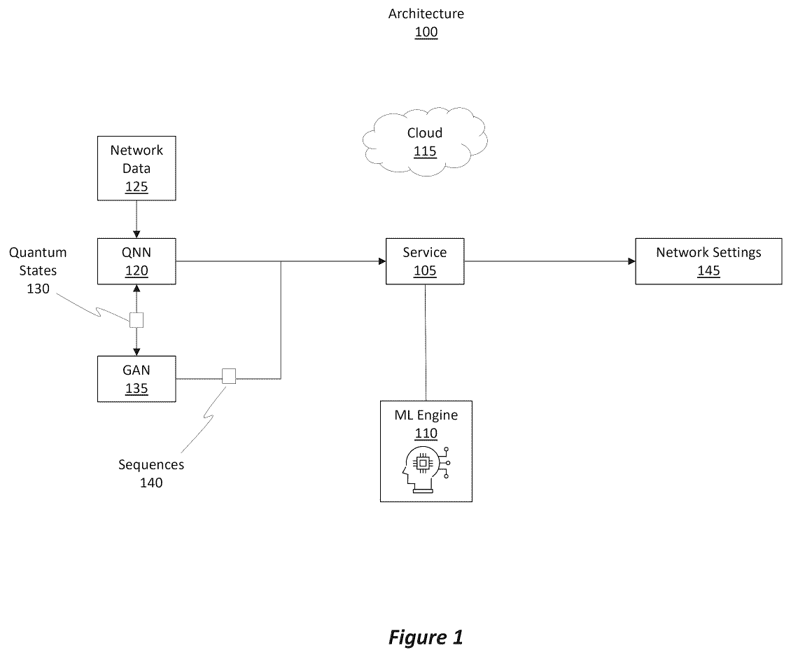

Having just described some of the various advantages provided by the disclosed embodiments, attention will now be directed to FIG. 1, which illustrates an example architecture 100 in which the disclosed principles may be employed. Architecture 100 shows a service 105.

As used herein, the term “service” refers to an automated program that is tasked with performing different actions based on input. In some cases, service 105 can be a deterministic classifier that operates fully given a set of inputs and without a randomization factor. In other cases, service 105 can be or can include a machine learning (ML) or artificial intelligence engine, such as ML engine 110. The ML engine 110 enables service 105 to operate even when faced with a randomization factor.

As used herein, reference to any type of machine learning or artificial intelligence (or large language model (LLM)) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a local service operating on a local device, such as an edge device. In some implementations, service 105 is a cloud service operating in a cloud 115 environment. In some implementations, service 105 is a hybrid service that includes a cloud component operating in the cloud 115 and a local component operating on a local device. These two components can communicate with one another.

Service 105 is generally tasked with the application of QNNs, such as QNN 120. The QNN 120 leverages the principles of quantum computing to process a wide array of network-related data, including traffic loads, user demands, and network conditions, as shown by network data 125. Unlike traditional neural networks, the disclosed QNN outputs quantum states 130 that represent various potential network configurations, each associated with a probability indicating its efficiency in terms of energy consumption.

Following the QNN analysis, the Generative Adversarial Network (GAN) 135 plays a relevant role. GAN 135 uses the quantum states 130 as inputs to generate the most probable network configuration sequences 140 that could lead to optimal energy consumption. This calculation involves a generator, which proposes potential configurations, and a discriminator, which assesses these configurations for realism and practicality based on real network conditions and energy consumption metrics. The result of this process is a prioritized list of network configurations, each mapped to its predicted energy efficiency.

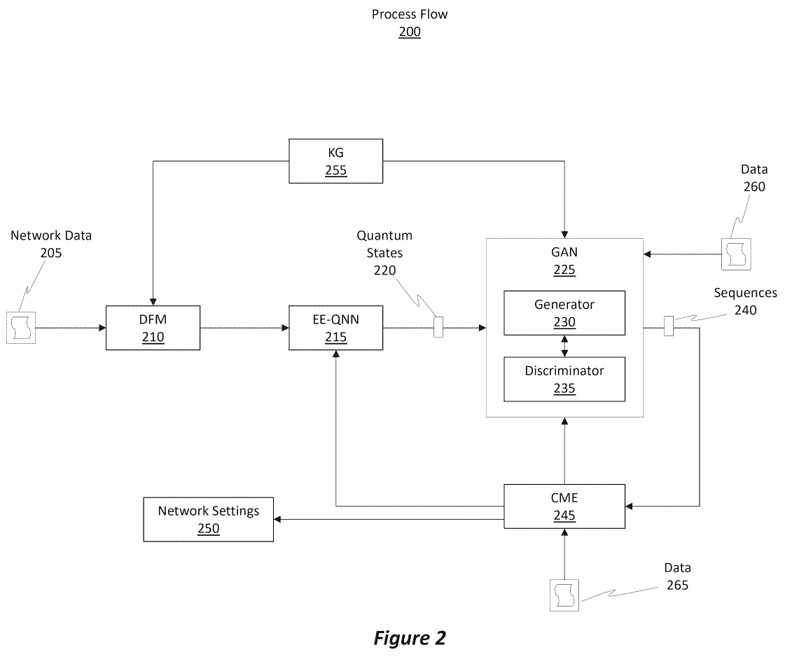

The final step in this approach involves the Configuration Management Engine (CME), which translates the theoretical configurations into actionable network settings 145. The CME engine meticulously selects from the proposed configurations to find the optimal balance between energy efficiency and network performance, ensuring the implementation does not compromise service quality or user experience. By employing this novel integration of QNNs and GANs, the disclosed solutions offer a dynamic, intelligent framework for network optimization, marking a significant advancement towards sustainable and efficient network management. FIG. 2 provides additional details regarding the operations that are performed within architecture 100 and that are facilitated by service 105.

More specifically, FIG. 2 shows a process flow 200 that is orchestrated by service 105 of FIG. 1. Process flow 200 can be implemented within architecture 100 of FIG. 1.

Process flow 200 addresses the challenge of energy efficiency in network systems through a novel and sophisticated approach, integrating QNNs and GANs into the configuration and execution planning of network entities and applications. Process flow 200 aims to optimize energy consumption by intelligently configuring network parameters. Service 105 can include the various components described in FIG. 2 and/or can direct those components to perform the disclosed operations.

QNNs are at the forefront of combining quantum computing principles with neural network architectures. Unlike classical neural networks that process and output information in binary (0s and 1s), QNNs operate on quantum states. These states, due to superposition, can represent multiple possible outcomes simultaneously, offering a richer and potentially more powerful computation paradigm for complex problems like network optimization.

In FIG. 2, network data 205 (such as traffic load, user demands, and network conditions) is initially provided to a Data Foundation Model (DFM) 210. Network data 205 corresponds to network data 125 of FIG. 1.

DFM 210 ensures that the various types of input data, ranging from structured data (e.g., network topology and traffic loads) to more unstructured or semi-structured data (e.g., user behavior patterns and environmental conditions), are effectively processed and utilized by the QNN. Thus, the DFM 210 performs an initial sorting and filtering operation. The output of the DFM 210 is then provided to the energy efficient QNN (i.e. EE-QNN 215). The EE-QNN 215 corresponds to the QNN 120 of FIG. 1.

The EE-QNN 215 processes this input data and outputs quantum states 220. Each quantum state represents a possible configuration of the network but does not directly map to a binary result. Instead, these quantum states 220 indicate the probability of various configurations and their potential efficiency.

The quantum states 220 are provided as input to the GAN 225, which corresponds to GAN 135. The GAN 225 includes two models: a generator 230, which creates data, and a discriminator 235, which evaluates that data. Here, the GAN 225 takes the quantum states 220 from the EE-QNN 215 as input. The task of the GAN 225 is to generate the most probable state sequences of the network configurations that could lead to optimal energy consumption.

The generator 230 in the GAN 225 works to produce K most probable binary state sequences based on the quantum states. The generator 230 simulates different network configurations and predicts their energy consumption. The discriminator 235 evaluates these sequences to ensure that the generated configurations are realistic and practical for the given network conditions.

The output of this step is a list of K most probable binary state sequences 240, each associated with its predicted energy consumption. The predicted energy consumption data helps prioritize configurations that could potentially offer the best energy efficiency.

The Configuration Management Engine (CME 245) takes the list of K most probable binary state sequences 240 from the GAN 225. Each sequence represents a specific configuration of network settings, such as concurrent execution of certain applications (e.g., rApp/Xapp), cell activation/deactivation, and/or physical resource block (PRB) allocation strategies (shared, proprietary, prioritized slices), among others.

CME 245 maps each binary state sequence to an actual network configuration. CME 245 decides how to adjust the network's settings to match one of the K most efficient configurations suggested by the GAN 225. The network settings 250 are representative of the output of the CME 245. One objective of the disclosed embodiments is to implement the network configuration that promises optimal energy efficiency without compromising on service quality or user experience.

As generally mentioned earlier, the introduction of QNNs for processing network data and generating quantum states as output is a great advancement in network optimization strategies, particularly in the context of enhancing energy efficiency without compromising network performance. This innovative approach shifts away from the conventional binary data processing utilized by classical neural networks, paving the way for a new paradigm in which network configurations are conceptualized and represented as quantum states.

Quantum states, characterized by the principle of superposition, are particularly relevant to the disclosed embodiments. Superposition allows a quantum bit (qubit) to exist in multiple states simultaneously, unlike classical bits that are confined to a strict binary existence of 0 or 1. When applied to network data processing, this principle enables a single quantum state to represent a multitude of potential network configurations concurrently. This quantum representation can embody various combinations of network parameters and settings, each with associated probabilities that reflect their potential effectiveness and efficiency.

This quantum-based representation is instrumental in conducting a more detailed and comprehensive analysis of network configurations. By exploiting the superposition principle, QNNs can evaluate a broad spectrum of configuration possibilities and their interrelated effects in a single computational step. This approach transcends the limitations of classical computing, which require sequentially processing each potential configuration to gauge its viability. Consequently, QNNs can rapidly identify the most optimal network settings that strike a harmonious balance between maintaining high performance levels and minimizing energy consumption.

Moreover, the quantum state output of QNNs encapsulates not just the static properties of network configurations but also the dynamic interplay of various network variables and their cumulative impact on the network's overall energy efficiency and performance. This dynamic representation allows for a deeper understanding of how changes in one aspect of the network might impact others, facilitating a holistic approach to network optimization.

The use of QNNs to generate quantum states as a model output represents a significant leap forward in network management. The disclosed principles provide a powerful and efficient tool for navigating the complexities of network optimization, leveraging the unique advantages of quantum computing to address the dual objectives of enhancing energy efficiency and ensuring robust network performance. Through this quantum-informed lens, network operators can explore and implement configuration strategies that were previously beyond the reach of classical computational approaches, marking a new era in the pursuit of sustainable and efficient network operations.

The disclosed embodiments are also beneficially configured to leverage QNN-GAN integration for energy-efficient configuration. That is, the disclosed embodiments strategically use GANs to further refine the quantum state outputs from QNNs into actionable network configurations. This process entails the transformation of abstract quantum states (i.e. representations of potential network configurations with associated probabilities) into concrete, binary state sequences that can be directly applied to manage the network.

The GAN architecture plays a relevant role in this transformation. As shown in FIG. 2, GAN 225 includes two components: the generator 230 and the discriminator 235. The function of the generator 230 is to take the quantum states 220 provided by the EE-QNN 215 as input and produce binary state sequences that represent specific network configurations. These configurations are designed to optimize energy consumption based on the probabilistic insights gained from the quantum states. In this regard, the generator 230 translates the high-dimensional, probabilistic quantum states 220 into a format (e.g., binary sequences) that directly corresponds to practical network settings.

Simultaneously, the discriminator 235 evaluates the realism and feasibility of the configurations proposed by the generator 230. The discriminator 235 assesses whether these configurations, now in a binary format, are practical and can effectively reduce energy consumption without sacrificing the network's performance or the quality of service experienced by users. This evaluative process involves comparing the generated configurations against a set of criteria derived from real-world network conditions and performance metrics.

The iterative interaction between the generator 230 and discriminator 235 ensures that the final binary state sequences 240 are not only grounded in the theoretical potential indicated by the QNN outputs but also aligned with practical, operational considerations of the network. This iterative refinement process allows for a nuanced approach to network configuration, where energy efficiency is maximized through carefully selected adjustments to network settings.

By converting quantum state probabilities into actionable binary sequences, the GAN 225 bridges the gap between the theoretical models provided by quantum computing and the tangible requirements of network management. This enables network operators to implement data-driven, energy-efficient configurations that are validated for practical viability. The result is a sophisticated method for enhancing network energy efficiency, leveraging the depth of analysis afforded by quantum computing and the practical applicability ensured by generative adversarial modeling.

The disclosed embodiments also beneficially enable the dynamic mapping of quantum-inspired configurations. This unique configuration lies in the sophisticated mechanism developed to map the K most probable binary state sequences 240, derived from the GAN 225, which is informed by the EE-QNN 215, directly into optimized network configurations. This process represents a unique innovation by effectively translating abstract, quantum-inspired computational outcomes into tangible, actionable settings for real-world network operations. One aspect of this innovation is the ability of the CME 245 to not only interpret these sequences as viable network configurations but also to evaluate and prioritize them based on their potential to enhance energy efficiency within the network's existing operational framework.

This mapping process involves an intricate analysis where each binary state sequence (e.g., included among the sequences 240), which represents a specific configuration of network parameters (e.g., such as device statuses, App states, traffic routing, and resource allocations), is assessed for its effectiveness in reducing energy consumption while maintaining or even enhancing network performance and service quality. The uniqueness here is not just in the translation of theoretical data into practical configurations, but doing so in a manner that dynamically aligns with the network's current and projected states. This ensures that the implemented configurations are not only optimized for energy efficiency but are also adaptable to changing network conditions and demands.

By focusing on the precise mapping of these K most probable state sequences into optimized configurations, the disclosed embodiments offer a targeted approach to network management. The embodiments leverage the depth and breadth of quantum computing's analytical capabilities, as captured in the quantum state outputs of QNNs, and the strategic evaluation strength of GANs. This methodological synergy enables network operators to implement deeply informed, highly effective energy-saving measures across their networks, showcasing a great step forward in the pursuit of sustainable, efficient, and high-performing network systems.

Further details regarding the disclosed principles will now be provided. Initially, the embodiments use QNNs to process network data and to generate quantum states that represent various possible configurations of the network. This step is relevant because it leverages the principles of quantum computing to enhance the decision-making process for network optimization, especially in terms of energy efficiency.

FIG. 2 shows some of the various inputs that are provided to the EE-QNN 215. In particular, the network data 205 includes a wide array of network-related data. Examples of such data include a network graph, nodes that represent physical and virtual network components (e.g., such as cell sites, base stations, routers, switches, and servers, applications, etc.), edges that operate as connections between nodes, which could represent physical links (e.g., fiber optic cables, wireless connections) or logical connections in the case of virtualized network functions.

Additional input data includes node attributes. These attributes represent characteristics of the node, such as node type, operational status (active, idle, off), energy consumption, processing capabilities, and available resources.

Additional input includes edge attributes, traffic load details, total volume of data traffic over time, types of traffic (e.g., video, audio, web browsing), peak vs. off-peak traffic patterns, user demands and behavior, the number of active users and devices, an identification of service types that are being used or desired (e.g., high bandwidth, low latency), mobility patterns (e.g., stationary, moving within a cell, transitioning between cells).

Another input is network conditions, which may include signal strength and quality indicators, network latency and packet loss rates, availability and status of network resources (e.g., bandwidth, cells), network infrastructure status. The status can include cell operational status such as active, idle, or powered down.

Another input includes configuration data for network elements (e.g., base stations, antennas, rApps/xApps). Additional input includes deployment of network slicing instances, energy consumption data, such as historical and current energy usage of network components, energy efficiency ratings of hardware and infrastructure, power-saving modes and their effects on performance. Additional input data includes resource allocation and utilization, such as the current allocation of physical resource blocks (PRBs), the utilization rates of network slices, the efficiency of resource usage (e.g., bandwidth, computing power).

Environmental conditions can also be included as input. These conditions include geographic and topological data impacting signal propagation, weather conditions affecting network operations, environmental constraints on infrastructure deployment (e.g., urban vs. rural). Quality of service (QoS) requirements can also operate as input. These requirements may include latency requirements for different services (e.g., real-time gaming), bandwidth and throughput, reliability and availability targets.

Predictive indicators can also be input. These indicators may include forecasted traffic growth and user behavior changes, predicted movements of large groups of users (e.g., during events), and trends in service adoption and technology evolution.

The embodiments can handle diverse input data for the EE-QNN 215. Initially, these diverse types of input can be filtered or optimized via the use of the DFM 210. The DFM 210 ensures that the various types of input data, ranging from structured data like network topology and traffic loads to more unstructured or semi-structured data like user behavior patterns and environmental conditions, are effectively processed and utilized by the EE-QNN 215.

The DFM 210 can operate in various ways, such as by performing data normalization and standardization. The DFM 210 can also help ensure that data from different sources and formats is converted into a uniform format that the EE-QNN 215 can process. This conversion is relevant for dealing with diverse data types, such as numerical values for traffic loads and categorical data for node types or operational statuses.

The DFM 210 can also perform data encoding into quantum states. Quantum computers operate on qubits, which can represent and process vast amounts of data through superposition and entanglement. Encoding classical data into quantum states is a relevant step for leveraging quantum computing's parallelism.

The challenge of maintaining the probability information of quantum states in the context of a system that integrates QNNs and GANs for network configuration, especially under the constraint of quantum measurement that collapses these states into finite outcomes, is significant. However, this can be addressed through several innovative approaches within the framework of quantum computing and network optimization.

For instance, the embodiments can implement the ensemble of measurements. One approach to preserving probabilistic information is to perform an ensemble of quantum measurements over multiple identical quantum states prepared in the same superposition. This technique allows for the collection of a distribution of outcomes, which can be used to approximate the original probabilistic information encoded in the quantum state. By analyzing the distribution of these measurement outcomes, it is possible to infer the probabilities associated with different network configurations or states, thus retaining a form of probabilistic information even after individual quantum state collapses.

Some embodiments can also use quantum state tomography. Quantum state tomography is a method used to reconstruct the quantum state based on measurements performed on a large number of identically prepared quantum systems. By applying this technique, it is possible to estimate the density matrix of a quantum state, which encodes the probabilities of the system's possible states.

The embodiments can also harness hybrid quantum-classical processing. In a hybrid quantum-classical system, quantum computation is used for specific tasks that benefit from quantum parallelism, while classical systems handle tasks like data aggregation and decision-making. After quantum measurement, a classical system can aggregate outcomes from repeated measurements or perform computations based on data from quantum state tomography to maintain a probabilistic model.

The embodiments can also perform repeated measurements with quantum error correction. Repeated measurements of quantum states, combined with quantum error correction techniques, can help in mitigating the effects of quantum state collapse and in preserving information about the probabilities of different outcomes. Quantum error correction codes are designed to protect quantum information against errors due to decoherence and other quantum noise. By applying these codes, it is possible to perform repeated measurements on quantum systems without significantly disturbing the encoded probabilistic information, thus allowing for its extraction and use in network optimization.

The embodiments can also implement amplitude estimation algorithms. Quantum amplitude estimation algorithms offer a way to estimate the amplitude (e.g., probability) of a particular state without directly measuring the state itself. These algorithms can provide an estimate of the probabilities associated with different scenarios. This technique requires fewer measurements than direct statistical methods and can preserve information about the probabilities even after the quantum state has been measured.

Additionally, the embodiments can also perform probabilistic interpretation of measurement outcomes. The outcomes of quantum measurements themselves can be interpreted in a probabilistic manner. Each measurement outcome can be associated with a likelihood, based on the quantum state's amplitude for that outcome prior to measurement. By collecting and analyzing the outcomes of multiple measurements, a probabilistic model of the network can be constructed, reflecting the likelihood of various network states and configurations.

Some embodiments perform feature selection and dimensionality reduction. Given the complexity and high dimensionality of the input data, it is beneficial to identify the most relevant features for the QNN's tasks. This step helps in reducing computational complexity and focusing on information that contributes most significantly to energy efficiency and network performance.

The embodiments can also handle temporal and spatial data. Network data often contains temporal and spatial components, such as user mobility patterns or time-varying traffic loads. Handling these aspects effectively is beneficial for making predictions and optimizations that are contextually relevant. One possible solution is incorporating time series analysis methods for temporal data and graph neural network techniques for spatial data, adapted for quantum computation where possible.

The embodiments can also utilize predictive indicators and forecasting models as part of the input. Doing so allows the QNN to not only react to current network conditions but also to anticipate future states and to adjust configurations proactively. The embodiments can train classical predictive models on historical data to forecast metrics and then encode these forecasts as input to the QNN.

To enhance the model's ability to generalize from existing data and to improve its robustness against overfitting, especially in scenarios with limited training data, the embodiments can augment quantum data. One technique is to generate new quantum data points through quantum circuits that simulate variations in existing data or explore new states within the problem space.

Data fusion techniques can also be employed by the disclosed embodiments. These techniques combine information from various data sources and types to create a comprehensive view of the network state. This holistic approach is relevant for making well-informed optimization decisions. Techniques like multimodal data fusion adapted for quantum computation ensure that disparate data sources like network graphs, traffic patterns, and environmental conditions are effectively integrated.

The output from the QNN is not a set of binary decisions but rather is a set of quantum states that correspond to different possible network configurations. These quantum states are described by probabilities rather than definite values, representing the likelihood of each configuration's effectiveness in improving energy efficiency. The state space here is non-binary and can include various dimensions. One dimension relates to configuration probabilities. These probabilities are associated with each quantum state, indicating the likelihood of various network configurations being energy efficient (EE). Another dimension relates to energy efficiency metrics. Quantum states could represent metrics like power consumption levels, potential energy savings, and efficiency ratios under different configurations.

In the context of energy efficiency, the non-binary state space can define a multidimensional landscape where each dimension represents a potential configuration parameter (e.g., cell activation status, resource block allocation strategy, rApp/xApp execution plan). The quantum states outputted by the QNN offer a probabilistic understanding of how changes in these parameters could affect energy consumption, allowing for a nuanced approach to optimization.

The disclosed embodiments also incorporate the use of a knowledge graph (KG) 255, which can be integrated with the GAN 225. Incorporating the GAN 225 to optimize network configurations for energy efficiency involves a sophisticated interplay between the GAN's generator 230 and discriminator 235, guided by insights derived from QNN outputs and potentially augmented by the knowledge graph 255. This step focuses on generating and evaluating network configuration sequences to identify those that optimize energy consumption.

The primary task of the generator 230 is to create synthetic data that mimics real-world network configurations. The generator 230 takes quantum states from the EE-QNN 215, where the quantum states encode probabilities of various network configurations being energy efficient, and generates binary state sequences. These sequences represent possible network configurations.

The generator 230 uses the input quantum states 220 to explore the space of network configurations. The generator 230 applies learned patterns to propose configurations that are likely to be energy-efficient, considering both current network conditions and historical data.

The discriminator 235 evaluates the realism and feasibility of the configurations generated by the generator 230. The discriminator 235 uses knowledge of real network conditions and configurations to judge whether the proposed configurations are practical and could achieve the predicted energy efficiencies. The discriminator 235 compares the synthetic configurations against a dataset of known, realistic network configurations and their energy consumption metrics. The discriminator 235 provides feedback to the generator 230, which then adjusts its parameters to improve the quality of the generated configurations.

The knowledge graph (KG) 255 can significantly enhance the capability of the GAN 225 by providing a structured and rich source of domain knowledge about network configurations, performance metrics, and energy consumption patterns. The knowledge graph 255 integrates detailed information about network elements, historical performance data, relationships between different configurations and their outcomes, and external factors affecting energy consumption. This structured knowledge supports both the generator 230 and discriminator 235 by offering context and reference points for evaluating configurations.

The knowledge graph 255 is queried during the generation and discrimination phases to fetch relevant information that aids in the creation of realistic network configurations and in the evaluation of those configurations'practicality and efficiency.

The inputs and outputs of the GAN 225 can be summarized as follows. Regarding the inputs, quantum states 220 from the EE-QNN 215 are provided as input. These quantum states 220 are encoded probabilities of various network configurations that are potentially energy efficient.

Another input is real network configuration data 260. This data 260 is used by the discriminator 235 to evaluate the realism of generated configurations.

Data from the knowledge graph 255 can also operate as input. This data provides contextual and historical data to both the generator 230 and discriminator 235 to inform the generation and evaluation processes.

Regarding the outputs of the GAN 225, the outputs include the K most probable binary state sequences 240. These sequences represent the network configurations that are predicted to be most energy-efficient according to the GAN 225.

Another output is the energy consumption predictions. For each of the K configurations, predicted metrics of energy consumption are provided.

Additional details will now be provided for the operations of the GAN 225. The GAN 225 generates network configurations. The generator 230, utilizing quantum state inputs and augmented by insights from the knowledge graph 255, proposes a set of network configurations that are likely to optimize energy efficiency.

The GAN 225 also evaluates against realism and practicality. The discriminator 235, leveraging real-world data (e.g., data 260) and the knowledge graph 255, assesses the proposed configurations for their realism and potential for achieving the predicted energy efficiencies.

The GAN 225 also relies on a feedback loop. The evaluations of the discriminator 235 are fed back to the generator 230. The generator 230 then adjusts its parameters and strategies to improve the realism and effectiveness of its subsequent configurations. Throughout this process, the knowledge graph 255 provides additional insights, such as correlations between configurations and energy efficiency, historical trends, and the impact of external factors, to refine both the generation and evaluation phases.

The CME 245 is a relevant component in the proposed framework for optimizing network configurations with a focus on energy efficiency. Its primary role is to translate theoretical models and predictions into actionable network configurations (i.e. network settings 250) that can be deployed in real-world network environments.

The CME 245 can implement configuration mapping. The CME 245 takes the theoretical binary state sequences 240 generated by the GAN 225 and maps them to practical network configurations. This mapping involves translating the abstract representations of network settings into specific commands and settings for network hardware and software.

Based on the list of K most probable binary state sequences 240 for optimal energy efficiency, the CME 245 decides which configuration to implement. It considers current network conditions, historical performance data, and potential impacts on service quality and user experience, as generally represented by data 265. The CME 245 dynamically adjusts network settings in real-time or near-real-time, allowing the network to adapt to changing conditions and demands while maintaining optimal energy efficiency.

The CME 245 can also continuously monitor the performance of the implemented configurations and can provide feedback to the GAN 225 and EE-QNN 215 for future optimization cycles. In doing so, the CME 245 creates a feedback loop that enhances prediction accuracy and optimization effectiveness over time.

The inputs and outputs of CME will now be described. One input to the CME 245 is the K most probable binary state sequences 240. These sequences 240 represent the configurations most likely to optimize energy efficiency. Another input is the current network conditions, which are reflected by the data 265. Real-time data about the network's status, including traffic loads, resource utilization, and operational statuses of network elements can be included in the data 265. Another input, which can also be included in the data 265, includes historical performance data. This information includes Information on past configurations, their outcomes, and impacts on energy consumption and service quality.

Regarding the outputs of the CME, one output is the network settings 250, which can include network configuration commands. These commands may include specific instructions and settings to adjust network elements according to the chosen optimal configuration. The network settings 250 may also include performance and monitoring reports detailing data on the implemented configuration's performance, including its effects on energy efficiency and service quality.

The CME 245 receives input from the GAN 225, which is informed by quantum state probabilities generated by the EE-QNN 215. This input guides the configuration decisions of the CME 245.

The CME 245 can also interact with other network data sources. For instance, the CME 245 can interact with various data sources to gather current network conditions and historical performance data. These sources include network monitoring tools, performance management databases, and user feedback systems. The CME 245 can communicate with the distributed control layers and orchestration platforms to implement the desired configurations across the network's physical and virtual resources. For configurations affecting specific applications or services, the CME 245 can coordinate with application lifecycle management systems to ensure that changes align with service-level agreements (SLAs) and application performance requirements.

The deployment location of the CME 245 within a network architecture, especially considering its operation level (non-real-time vs. near-real-time), is relevant for understanding how it interacts with other network components and manages the network's configurations for optimizing energy efficiency.

In some implementations, the CME 245 has a non-real-time deployment. In many network architectures, particularly those that manage complex configurations and require extensive analysis and decision-making, the CME 245 is deployed at a non-real-time (Non-RT) level. This level is characterized by various features. For instance, the non-RT level handles tasks that do not require immediate response times. These tasks often involve strategic decision-making, long-term planning, and analysis of large datasets to inform those decisions.

At this level, the CME 245 processes inputs from the GAN 225 (which itself incorporates outputs from the EE-QNN 215), evaluates various network configurations, and decides on the optimal configurations for energy efficiency. This process might include analyzing historical performance data, predicting future network conditions, and formulating strategic configuration changes.

Being located at the non-RT level, the CME 245 operates within centralized network management systems, where it can access a comprehensive view of the network. This centralized perspective is relevant for making informed decisions that impact the network as a whole.

The CME 245 can also have a near-teal-time deployment. The concept of a distributed CME 245 introduces the ability for parts of the configuration management process to operate at the near-real-time (Near-RT) layer. This adaptation is significant for several reasons.

For instance, the near-RT layer is designed to handle tasks that require quick responses, typically in the range of milliseconds to a few seconds. This layer is closer to the operational dynamics of the network, enabling rapid adjustments to configurations in response to changing conditions.

In a distributed CME 245 scenario, the inference of near-RT policies allows for the dynamic adjustment of network configurations with minimal delay. This capability is relevant for responding to sudden changes in network load, mobility events, or shifts in user demand, where waiting for centralized, non-real-time decision-making could lead to suboptimal performance or inefficiencies.

The distributed CME 245 components or instances located at the near-RT layer are often deployed closer to the edge of the network or within specific network domains. This decentralized approach allows for localized decision-making, leveraging real-time data from nearby network elements and users to make rapid configuration adjustments.

The CME 245 can also have distributed CME integration, such as hierarchical coordination. The integration of non-real-time and near-real-time layers is benefitted by careful coordination. Strategic, long-term decisions made at the non-RT level inform the operational policies and rules executed at the near-RT level. This ensures consistency in achieving the overarching goals of energy efficiency and service quality.

Policies determined at the non-RT level are effectively disseminated to the near-RT components of the CME 245. This involves translating high-level strategies into actionable rules that can be implemented quickly in response to network conditions.

To maintain optimal performance and efficiency, feedback from the near-RT layer's operations is aggregated and analyzed at the non-RT level. This feedback informs future strategic decisions, creating a dynamic loop that continuously improves network management.

Within the disclosed framework for energy-efficient network optimization, the CME 245 acts as the bridge between theoretical optimization models and practical network operation. The CME 245 integrates closely with AI-driven models (QNN and GAN) for decision support and relies on real-time network data to make informed configuration choices. Its dynamic reconfiguration capabilities enable the network to adapt to evolving conditions, optimizing for energy efficiency without compromising performance or user experience.

The deployment and effectiveness of the CME 245 may depend on its ability to rapidly process inputs, make decisions, and implement changes across a complex network infrastructure. This may rely on sophisticated algorithms for decision-making, robust interfaces for interacting with other network systems, and advanced capabilities for monitoring and adjusting configurations in response to real-world outcomes.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

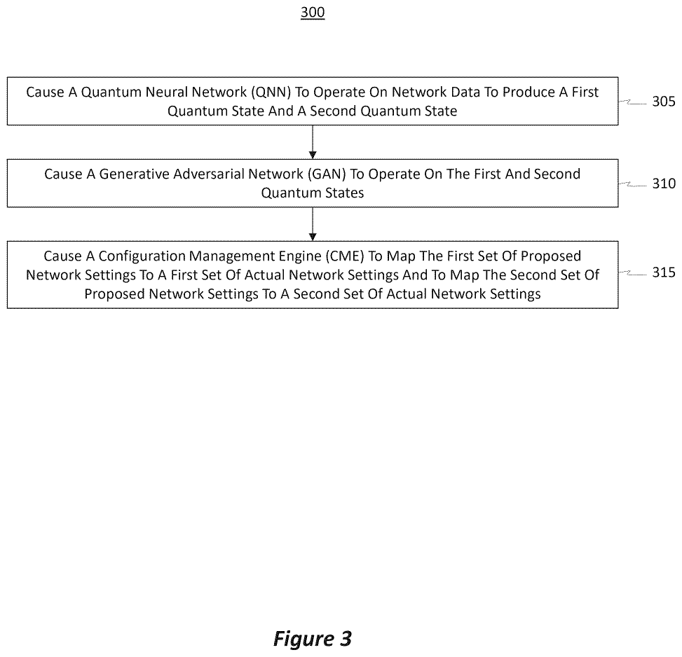

Attention will now be directed to FIG. 3, which illustrates a flowchart of an example method 300 for generating a simulation of network settings for a network and for evaluating those settings based on an energy consumption metric. Method 300 can be implemented within the architecture 100 of FIG. 1, and can be performed by the service 105. Service 105 of FIG. 1 may include or may be associated with the DFM 210 of FIG. 2, the EE-QNN 215, the GAN 225, the CME 245, and the KG 255.

Method 300 includes an act (act 305) of causing a quantum neural network (QNN) to operate on network data to produce a first quantum state and a second quantum state. The first quantum state represents a first potential network configuration for a network. The second quantum state represents a second potential network configuration for the network.

The first quantum state includes a first energy metric representative of a first level of energy consumed by the network if the network were configured using the first potential network configuration. Similarly, the second quantum state includes a second energy metric representative of a second level of energy consumed by the network if the network were configured using the second potential network configuration.

Optionally, the network data is filtered network data that is filtered by a data foundation model. The network data may include structured data and unstructured data. The network data may include a network topology of the network and a traffic load of the network. The network data may include behavior patterns associated with the network and environmental conditions associated with the network. The network data may include a network graph, node data, and edge data. The network data may include a list of cell sites, base stations, routers, switches, servers, and applications.

Act 310 includes causing a generative adversarial network (GAN) to operate on the first and second quantum states. The GAN generates a first simulation of the network using the first quantum state and a second simulation of the network using the second quantum state. An output of the GAN includes a first set of proposed network settings used as a part of the first simulation and a second set of proposed network settings used as a part of the second simulation.

In some embodiments, the GAN includes a generator model and a discriminator model. The generator model generates the first simulation of the network using the first quantum state and the second simulation of the network using the second quantum state. The discriminator model assesses the first simulation and the second simulation based on a combination of actual network conditions of the network and one or more energy consumption metrics. Optionally, the actual network conditions are obtained from a knowledge graph.

The GAN is configured to translate the first and second quantum states into binary sequences comprising the first and second sets of proposed network settings. In some implementations, the first (and second) set of proposed network settings includes settings associated with one or more of the following: a device state, an application state, traffic routing, or resource allocation.

Act 315 includes causing a configuration management engine (CME) to map the first set of proposed network settings to a first set of actual network settings and to map the second set of proposed network settings to a second set of actual network settings.

Optionally, method 300 includes an act of causing the CME to prioritize the first set of actual network settings over the second set of actual network settings based on a determination that the first set of actual network settings leads to a higher network energy efficiency relative to the second set of actual network settings.

In some scenarios, the CME determines how to adjust the network to implement the first set of actual network settings. The network may then be adjusted to implement the first set of actual network settings.

The CME can provide feedback to the QNN. Similarly, the CME can provide feedback to the GAN. In performing the disclose operations, the embodiments are able to optimize the performance of a network in terms of energy consumption.

It should be recognized how any of the disclosed features can be recited in combination with any of the other combined features. Thus, unless explicitly recited otherwise, features recited herein are combinable with other features, regardless of whether those features are illustrated in different figures or different portions of this disclosure.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, classifiers, and component are examples of terms that may refer to software objects or routines that execute on the computing system. The different components, modules, engines, services, and classifiers described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

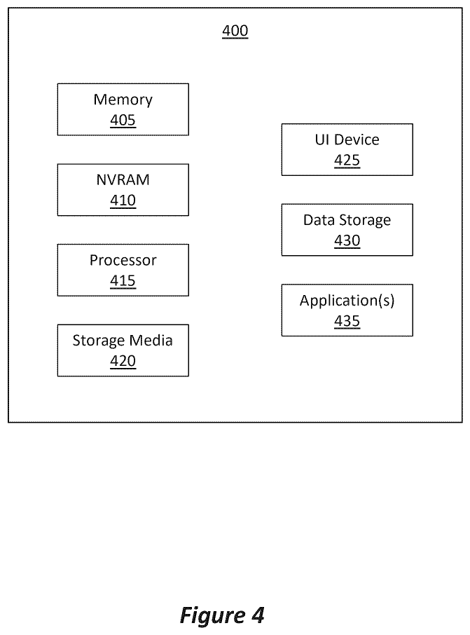

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. This example device can be implemented in architecture 100 of FIG. 1 and can host service 105. Also, where any of the aforementioned elements comprise or consist of a virtual machine (VM), that VM may constitute a virtualization of any combination of the physical components disclosed in FIG. 4.

In the example of FIG. 4, the physical computing device 400 includes a memory 405 which may include one, some, or all, of random access memory (RAM), non-volatile memory (NVM) 410 such as NVRAM for example, read-only memory (ROM), and persistent memory, one or more hardware processors 415, non-transitory storage media 420, UI device 425, and data storage 430. One or more of the memory 405 of the physical computing device 400 may take the form of solid-state device (SSD) storage. Also, one or more applications 435 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 400 may also be representative of an edge system, a cloud-based system, a datacenter or portion thereof, or other system or entity.

The disclosed embodiments can be implemented in numerous different ways, as described in the various different clauses recited below.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
causing a quantum neural network (QNN) to operate on network data to produce a first quantum state and a second quantum state, wherein:
the first quantum state represents a first potential network configuration for a network, and the second quantum state represents a second potential network configuration for the network, and
the first quantum state includes a first energy metric representative of a first level of energy consumed by the network if the network were configured using the first potential network configuration, and the second quantum state includes a second energy metric representative of a second level of energy consumed by the network if the network were configured using the second potential network configuration;
causing a generative adversarial network (GAN) to operate on the first and second quantum states, wherein the GAN generates a first simulation of the network using the first quantum state and a second simulation of the network using the second quantum state, and wherein an output of the GAN includes a first set of proposed network settings used as a part of the first simulation and a second set of proposed network settings used as a part of the second simulation; and
causing a configuration management engine (CME) to map the first set of proposed network settings to a first set of actual network settings and to map the second set of proposed network settings to a second set of actual network settings.

2. The method of claim 1, wherein the method further includes:
causing the CME to prioritize the first set of actual network settings over the second set of actual network settings based on a determination that the first set of actual network settings leads to a higher network energy efficiency relative to the second set of actual network settings.

3. The method of claim 1, wherein the GAN includes a generator model and a discriminator model.

4. The method of claim 3, wherein the generator model generates the first simulation of the network using the first quantum state and the second simulation of the network using the second quantum state.

5. The method of claim 4, wherein the discriminator model assesses the first simulation and the second simulation based on a combination of actual network conditions of the network and one or more energy consumption metrics.

6. The method of claim 5, wherein the actual network conditions are obtained from a knowledge graph.

7. The method of claim 1, wherein the network data is filtered network data that is filtered by a data foundation model.

8. The method of claim 1, wherein the network data includes structured data and unstructured data.

9. The method of claim 1, wherein the network data includes a network topology of the network and a traffic load of the network.

10. The method of claim 1, wherein the network data includes behavior patterns associated with the network and environmental conditions associated with the network.

11. A computer system comprising:
one or more processors; and
one or more hardware storage devices that store instructions that are executable by the one or more processors to cause the computer system to:
cause a quantum neural network (QNN) to operate on network data to produce a first quantum state and a second quantum state, wherein:
the first quantum state represents a first potential network configuration for a network, and the second quantum state represents a second potential network configuration for the network, and
the first quantum state includes a first energy metric representative of a first level of energy consumed by the network if the network were configured using the first potential network configuration, and the second quantum state includes a second energy metric representative of a second level of energy consumed by the network if the network were configured using the second potential network configuration;
cause a generative adversarial network (GAN) to operate on the first and second quantum states, wherein the GAN generates a first simulation of the network using the first quantum state and a second simulation of the network using the second quantum state, and wherein an output of the GAN includes a first set of proposed network settings used as a part of the first simulation and a second set of proposed network settings used as a part of the second simulation; and
cause a configuration management engine (CME) to map the first set of proposed network settings to a first set of actual network settings and to map the second set of proposed network settings to a second set of actual network settings.

12. The computer system of claim 11, wherein the CME determines how to adjust the network to implement the first set of actual network settings.

13. The computer system of claim 11, wherein the network is adjusted to implement the first set of actual network settings.

14. The computer system of claim 11, wherein the CME provides feedback to the QNN.

15. The computer system of claim 11, wherein the CME provides feedback to the GAN.

16. The computer system of claim 11, wherein the GAN translates the first and second quantum states into binary sequences comprising the first and second sets of proposed network settings.

17. The computer system of claim 11, wherein the first set of proposed network settings includes settings associated with one or more of the following: a device state, an application state, traffic routing, or resource allocation.

18. The computer system of claim 11, wherein the network data includes a network graph, node data, and edge data.

19. The computer system of claim 11, wherein the network data includes a list of cell sites, base stations, routers, switches, servers, and applications.

20. One or more hardware storage devices that store instructions that are executable by one or more processors to cause the one or more processors to:
cause a quantum neural network (QNN) to operate on network data to produce a first quantum state and a second quantum state, wherein:
the first quantum state represents a first potential network configuration for a network, and the second quantum state represents a second potential network configuration for the network, and
the first quantum state includes a first energy metric representative of a first level of energy consumed by the network if the network were configured using the first potential network configuration, and the second quantum state includes a second energy metric representative of a second level of energy consumed by the network if the network were configured using the second potential network configuration;
cause a generative adversarial network (GAN) to operate on the first and second quantum states, wherein the GAN generates a first simulation of the network using the first quantum state and a second simulation of the network using the second quantum state, and wherein an output of the GAN includes a first set of proposed network settings used as a part of the first simulation and a second set of proposed network settings used as a part of the second simulation; and
cause a configuration management engine (CME) to map the first set of proposed network settings to a first set of actual network settings and to map the second set of proposed network settings to a second set of actual network settings.
